(19) United States
(12) Patent Application Publication
(10) Pub. No.: US 2025/0068697 A1
(43) Pub. Date: Feb. 27, 2025

(54) FEATURE VECTOR CALCULATION APPARATUS, CLUSTERING APPARATUS, TRAINING APPARATUS, METHOD, AND STORAGE MEDIUM

(71) Applicant: KABUSHIKI KAISHA TOSHIBA, Tokyo (JP)

(72) Inventors: Shuhei NITTA, Tokyo (JP); Shun HIRAO, Kawasaki Kanagawa (JP); Yasutaka FURUSHO, Fuchu Tokyo (JP)

(73) Assignee: KABUSHIKI KAISHA TOSHIBA, Tokyo (JP)

(21) Appl. No.: 18/810,783

(22) Filed: Aug. 21, 2024

(30) Foreign Application Priority Data
Aug. 22, 2023 (JP) 2023-134793

(51) Int. Cl. G06F 18/2325; G06N 20/00

(52) U.S. Cl. CPC G06F 18/2325; G06N 20/00

(57) ABSTRACT

A feature vector calculation apparatus includes processing circuitry. The processing circuitry is configured to: acquire target data, a plurality of pieces of deformed data obtained by deforming the target data, the target data comprising a plurality of pieces of target data, and a trained model adapted to receive input of each of the pieces of deformed data and output a feature vector; calculate the feature vector using each of the pieces of the deformed data and the trained model; and calculate, for each of the pieces of target data, a degree of variation indicative of a degree of variation in the feature vector.

### CROSS-REFERENCE TO RELATED APPLICATIONS

This application is based upon and claims the benefit of priority from Japanese Patent Application No. 2023-134793, filed Aug. 22, 2023, the entire contents of which are incorporated herein by reference.

### FIELD

Embodiments described herein relate generally to a feature vector calculation apparatus, a clustering apparatus, a training apparatus, a method, and a storage medium.

### BACKGROUND

A feature vector calculation apparatus is mounted on a clustering apparatus configured to perform classification (also referred to as cluster division or clustering) using a feature vector output from a trained model, or a training apparatus configured to perform training on a trained model for use in the clustering apparatus.

Such a clustering apparatus is configured to perform classification (also referred to as “cluster division” or “clustering”) on target data which is a vector data group by using a trained model. For example, a clustering apparatus dimensionally compresses a vector data group using a method such as t-SNE, estimates the number of clusters, and performs classification on the dimensionally compressed vector data group using a trained model. A trained model identifies a cluster label (cluster ID) by, for example, an unsupervised learning method. Such a cluster label (cluster ID) identified by a trained model is used as, for example, training data in supervised learning for another trained model.

Generally, a data group targeted for clustering may include data harmful to clustering (hereinafter referred to as “harmful data”). Examples of data harmful to clustering include unidentifiable data and noisy data mixed in by mistake. Examples of unidentifiable data include data which more than 90% of people cannot correctly identify. For example, in the case of classifying a group of photos showing animals into two clusters, “dog” and “cat”, the group of photos may include, as unidentifiable data, an image in which an unidentifiable portion is enlarged, an image in which both a dog and a cat are shown, etc. Furthermore, as noisy data, images of a “horse”, a “vehicle”, etc., which have been mixed by mistake into a group of photos may be included in a group of photos serving as target data pieces.

Such pieces of harmful data may hinder correct clustering and become a factor that reduces clustering performance. In addition, such pieces of harmful data may obscure a boundary between clusters or form an unessential spurious cluster in a case of displaying feature vectors output from a trained model, thereby being a factor that reduces visibility of clustering results. Furthermore, due to the effects of these pieces of harmful data, the optimization of a trained model for data conversion into feature vectors becomes unstable during training or increases a time required for convergence during training. This may decrease training efficiency.

### BRIEF DESCRIPTION OF THE DRAWINGS

FIG. 1 is a diagram showing an example of a configuration of a clustering apparatus according to a first embodiment.

FIG. 2 is a flowchart showing an example of a processing procedure in display processing by the clustering apparatus according to the first embodiment.

FIG. 3 is a scatter diagram showing feature vectors in accordance with a degree of variation.

FIG. 4 is a scatter diagram showing feature vectors in accordance with a cluster.

FIG. 5 is a diagram showing an example of a configuration of a clustering apparatus according to a second embodiment.

FIG. 6 is a flowchart showing an example of a processing procedure in training processing by a training apparatus according to the second embodiment.

FIG. 7 is a diagram showing a configuration example of a feature vector calculation apparatus according to an application example.

### DETAILED DESCRIPTION

In general, according to one embodiment, a feature vector calculation apparatus includes processing circuitry. The processing circuitry is configured to: acquire target data, a plurality of pieces of deformed data obtained by deforming the target data, the target data comprising a plurality of pieces of target data, and a trained model adapted to receive input of each of the pieces of deformed data and output a feature vector; calculate the feature vector using each of the pieces of the deformed data and the trained model; and calculate, for each of the pieces of target data, a degree of variation indicative of a degree of variation in the feature vector.

Hereinafter, embodiments of a feature vector calculation apparatus, a clustering apparatus, a training apparatus, a method, and a storage medium will be described in detail with reference to the drawings. A feature vector calculation apparatus according to an embodiment is an apparatus configured to support classification (also referred to as “cluster division” or “clustering”) in consideration of harmful data. Examples of the feature vector calculation apparatus include a clustering apparatus and a training apparatus configured to train a trained model for use in the clustering apparatus. Furthermore, the feature vector calculation apparatus may be a retrieval apparatus configured to retrieve similar data using a feature vector output from the trained model. In the description below, structural elements having substantially the same functions will be denoted by the same reference symbols, and repeat description of such elements will be given only where necessary.

### First Embodiment

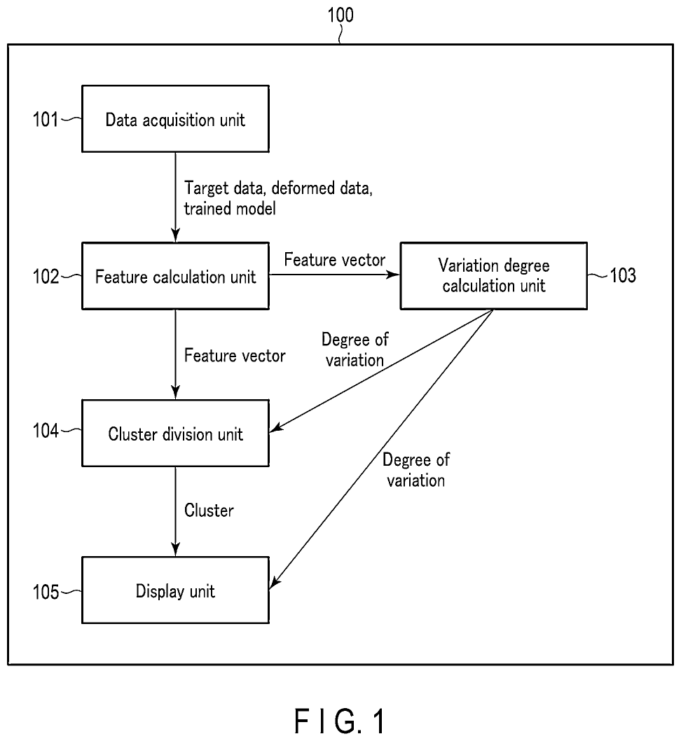

FIG. 1 is a diagram showing a configuration of a clustering apparatus 100 according to a first embodiment. The clustering apparatus 100 is an example of a feature vector calculation apparatus. The clustering apparatus 100 calculates a feature vector by inputting target data into a trained model, and performs clustering by using the feature vector. Furthermore, the clustering apparatus 100 is configured to display output from a trained model in order to check clustering performance using the trained model.

The clustering apparatus 100 includes a data acquisition unit 101, a feature calculation unit 102, a variation degree calculation unit 103, a cluster division unit 104, and a display unit 105.

The data acquisition unit 101 acquires target data, a plurality of pieces of deformed data obtained by deforming the target data, and a trained model.

The target data is data targeted for clustering. Examples of the target data include image data. For example, in a case where a group of images showing animals is divided (clustered) by animal type, the target data corresponds to the images showing animals. The target data is not limited to image data and may be data in other formats as long as the data serves as a target for clustering.

The deformed data is data generated by performing data augmentation on the acquired target data. As a method for data augmentation, a general method that is applicable to training of a trained model for performing clustering on images can be used. In data augmentation, a plurality of items of deformed data are generated with respect to one piece of target data. Each piece of deformed data is correlated with its corresponding piece of original target data.

The trained model receives input of target data and outputs a feature vector. That is, the trained model is a machine learning model that converts target data into a feature vector. To support clustering in consideration of harmful data, the present embodiment aims to improve clustering performance of a trained model and visibility of a clustering result. As the trained model, for example, a general machine learning model used for clustering a data group, such as a deep neural network (DNN), can be used. For example, as the trained model, a deep neural network model (DNN) trained by an unsupervised learning method such as IDFD can be used.

Furthermore, the trained model is trained by a training method using data augmentation. At the time of training the trained model, training is performed while pieces of deformed data which are generated from the same piece of target data through data augmentation are considered to be in the same class (category).

It is preferable that the trained model be trained by an unsupervised learning method using acquired target data. However, the trained model may be trained by a supervised learning method using a data set different from the acquired target data. In this case also, it is preferable that training be performed while pieces of deformed data which are generated from the same piece of target data through data augmentation are considered to be in the same class (category).

It is preferable that deformed data used to train the trained model and deformed data to be acquired be generated by the same data augmentation method. That is, deformed data is preferably data generated by the same method as the data augmentation method used to train the trained model.

The feature calculation unit 102 calculates a feature vector using the deformed data and the trained model. At this time, the feature calculation unit 102 inputs the deformed data into the trained model and acquires feature vectors output from the trained model. The feature calculation unit 102 may calculate the feature vectors using the target data and the trained model. At this time, the feature calculation unit 102 inputs the target data into the trained model and acquires the feature vectors output from trained model.

The variation degree calculation unit 103 calculates a degree of variation indicative of a degree of variation in feature vectors based on the feature vectors calculated from the deformed data. At this time, the variation degree calculation unit 103 extract feature vectors of pieces of deformed data generated based on the same piece of target data, from among feature vectors of pieces of deformed data calculated by the feature calculation unit 102, and calculates a degree of variation indicative of a degree of variation for each piece of target data. A degree of variation in target data is also used as a degree of variation in pieces of deformed data generated from the aforementioned target data.

The trained model trained using data augmentation is trained by a method that sets feature vectors of pieces of deformed data generated from the same piece of data so as to be close to be each other and considers the pieces of deformed data to be in the same class (category). Therefore, in a case where a plurality of pieces of deformed data generated based on harmful data are input into the trained model, the degree of variation in feature vectors output from the trained model becomes larger than that in a case where pieces of deformed data generated based on target data other than the harmful data are input into the trained model. The harmful data corresponds to target data which leads to a decrease in clustering accuracy and a decrease in visibility of a clustering result. The target data with a low degree of variation exhibits high reliability and low uncertainty, thereby being able to be considered as less likely to be harmful data. On the other hand, the target data with a low degree of variation exhibits low reliability and high uncertainty, thereby being able to be considered as highly likely to be harmful data.

The cluster division unit 104 calculates clusters by dividing the feature vectors into clusters. For clustering, a general clustering method such as a k-means can be used. Furthermore, various methods such as a centroid method and kernel density estimation can may be used for clustering.

As the number of clusters resulting from division by the process of clustering (hereinafter referred to as a “cluster number”), for example, a numerical value specified by a user of the clustering apparatus 100 can be used. In a case of referring to the scatter diagram of the second feature vectors in a space dimensionally compressed using a method such as PCA, tSNE, UMAP, etc., or a case in which a cluster number can be estimated in advance from the nature of data, a corresponding numeric value may be used as a cluster number.

In the present embodiment, the cluster division unit 104 divides target data into a plurality of clusters based on the degree of variation calculated by the variation degree calculation unit 103. At this time, the cluster division unit 104 sets a degree of importance for each feature vector in a cluster such that the effect on clustering decreases as a degree of variation increases. Specifically, the cluster division unit 104 decreases a degree of importance with respect to clustering of feature vectors with a high degree of variation.

For example, at the time of determining the center of gravity by k-means method, the cluster division unit 104 sets, as a weighting factor of a feature vector, a value that is inversely proportional to a degree of variation in the corresponding target data. In such a case, a feature vector generated from target data with a high degree of variation exhibits a small weighting factor, thereby reducing the effect on clustering of data which is likely to be harmful data.

In order to check the performance of the trained model, the display unit 105 visualizes and displays output of the trained model. For example, in a scatter diagram in which feature vectors output from the trained model are mapped, the display unit 105 displays each feature vector in such a manner that a corresponding clustering result is identifiable.

Furthermore, in a scatter diagram in which feature vectors output from the trained model are mapped, the display unit 105 displays each feature vector with a degree of emphasis according to a degree of variation. For example, the display unit 105 displays each feature vector of deformed data by changing its color, size, shape, transparency, etc., in accordance with a degree of variation in target data corresponding to the aforementioned deformed data. Furthermore, the display unit 105 may display a feature vector of target data with a degree of emphasis according to a degree of variation in the aforementioned target data.

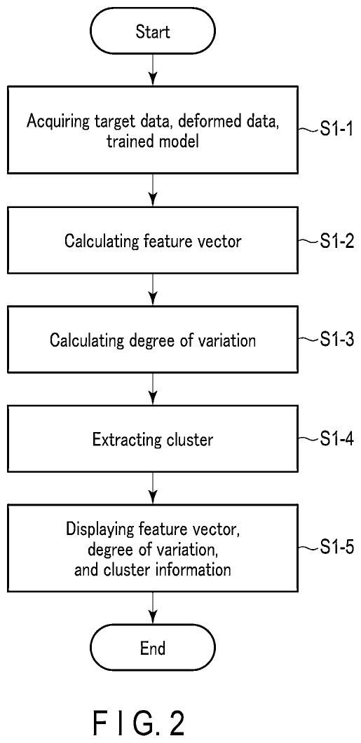

Next, the operation in the display processing executed by the clustering apparatus 100 according to the present embodiment will be described. FIG. 2 is a flowchart showing an example of a processing procedure in display processing. The display processing is processing of displaying a scatter diagram in which feature vectors output from the trained model are mapped, in order to allow the performance of the first trained model to be checked. Herein, as an example, a case will be described in which images showing one of the multiple types of animals are used as target data, and the images are each clustered for each animal type without using teacher label information.

The processing procedure in each instance of processing described below is merely an example, and each instance of processing can be appropriately changed where possible. Furthermore, with respect to the processing procedure described below, steps can be omitted, replaced, and added as appropriate according to the embodiment.

### (Display Processing)

### (Step S1-1)

First, the data acquisition unit 101 acquires a target data group including a plurality of pieces of target data, the first trained model, and the second trained model. At this time, the deformed data generated in advance may be acquired, or the deformed data may be acquired by executing data augmentation on the acquired target data.

The target data group is an image group input as images showing animals. It is assumed that each image is a color image with an image size of 32×32 [pixel]. In this case, each piece of target data is image data of 3072 (=32×32×3) dimensional vectors, and the target data group is a vector data group of 3072 (=32×32×3) dimensional vectors.

### (Step S1-2)

Next, the feature calculation unit 102 inputs target data and deformed data into the trained model, and acquires feature vectors output from the trained model, thereby calculating the feature vectors. It is assumed that the number of dimensions of the feature vector is 128.

### (Steps S1-3)

Next the variation degree calculation unit 103 calculates a degree of variation using a feature vector of deformed data for each piece of target data. Formula (1) is an example of a formula for calculating a degree of variation. In the formula (1), “V” represents a degree of variation. “Z′1” and “z′2” to “z′M” represent M feature vectors output from the trained model in a case where each of the M pieces of deformed data “x′1” to “x′M” are generated from one piece of the target data. “D” is a function representing a degree of divergence between two arguments. Examples of the function D include a function representing a sum of squad difference (SSD) or a sum of absolute difference (SAD). Meanwhile, in a case where the trained model holds a memory bank such as IDFD (a moving average value of a feature vector of each piece of target data), a value of the memory bank may be used as “u” in the formula (1).

$$V = 1 / M {\sum }_{i} D ( {z}_{i}^{′} , u ) \qquad ( 1 )$$

$$u = 1 / M {\sum }_{i} {z}_{i}^{′}$$

### (Step S1-4)

Next, the cluster division unit 104 calculates clusters obtained by dividing the feature vectors into clusters. At this time, the cluster division unit 104 divides the respective feature vectors into clusters in 30 categories using an unsupervised clustering method such as a k-means. For example, at the time of determining the center of gravity, the cluster division unit 104 sets, as a weighting factor of a feature vector, a value that is inversely proportional to a degree of variation in the corresponding target data. In such a case, a feature vector generated from target data with a high degree of variation has a small weighting factor, thereby reducing the effect on clustering of data which is likely to be harmful data.

### (Step S1-5)

The display unit 105 displays a scatter diagram in which the feature vectors are mapped. At this time, the display unit 105 displays a first scatter diagram and a second scatter diagram side by side. The first scatter diagram is a scatter diagram showing the mapped feature vectors being assigned variation information and the second scatter diagram is a scatter diagram showing the mapped feature vectors being assigned cluster information.

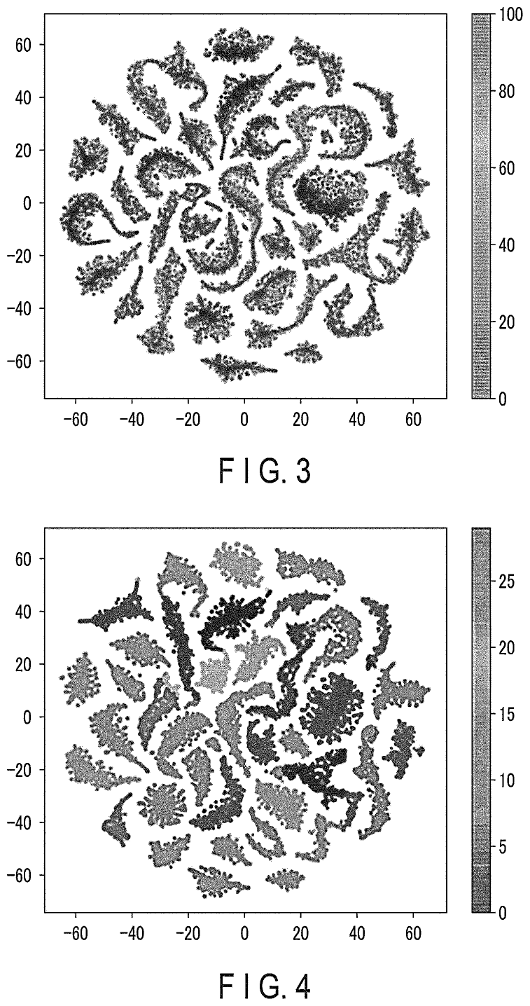

FIG. 3 is a diagram showing an example of the first scatter diagram. FIG. 3 shows the 128-dimensional feature vectors compressed into two dimensions for visualization. As a compression method, methods such as PCA, tSNE, and UMAP can be employed. FIG. 3 displays each feature vector of deformed data with emphasis according to a degree of variation in original target data. In FIG. 3, a pixel value (color density) of each point indicating a feature vector is changed and displayed according to a degree of variation in the corresponding target data. Furthermore, FIG. 3 shows a color bar indicating a value of a normalized degree of variation, too. Each point indicating each feature vector may be changed in terms of color, shape, size, transparency, etc., in accordance with a degree of variation and be displayed.

A user can check the clustering performance using the trained model by checking the first scatter diagram. The original data of feature vectors positioned in the vicinity of a boundary between clusters is often harmful data unsuitable for clustering. For this reason, a degree of variation in feature vectors positioned in the vicinity of a boundary between clusters is prone to increase. Therefore, the vicinity of a boundary between clusters is displayed with a deeper color than the remaining portions. This makes it easy to visually recognize the boundary between clusters even in a case where the boundary between clusters is vague on the scatter diagram. In this manner, visibility of a clustering result can be improved.

FIG. 4 is a diagram showing an example of the second scatter diagram. FIG. 4 shows the 128-dimensional feature vectors compressed into two dimensions for visualization. As a compression method, methods such as PCA, tSNE, and UMAP can be employed. In FIG. 4, a pixel value (color density) of each point indicating each feature vector of deformed data is changed and displayed according to the corresponding cluster. Furthermore, FIG. 4 shows a color bar indicating a cluster, too. Each point indicating each feature vector may be changed in terms of color, shape, size, transparency, etc., in accordance with the cluster.

A user can examine an image pattern of a feature vector output from the trained model by checking the second scatter diagram. Furthermore, a user can effectively check the clustering performance using the trained model by comparing the first scatter diagram and the second scatter diagram displayed side by side.

The first scatter diagram and the second scatter diagram may show the feature vectors of all pieces of deformed data. Furthermore, these diagrams may show in an integrated manner the feature vectors of pieces of deformed data which are generated from the same piece of target data. In such a case, for example, the diagrams may show the feature vectors of representative data selected from the plurality of pieces of deformed data or may display an average value of the feature vectors. Furthermore, the diagrams may show feature vectors calculated by inputting the target data instead of the feature vectors of deformed data into the trained data.

### Advantageous Effect of First Embodiment

The advantageous effects of the clustering apparatus 100 according to the present embodiment will be described below.

Generally, a data group targeted for clustering may include data harmful to clustering as “harmful data”. Examples of data harmful to clustering include unidentifiable data and noisy data mixed in by mistake. Examples of unidentifiable data include data which more than 90% of people cannot correctly identify. Such pieces of harmful data may obscure a boundary between clusters or form an unessential spurious cluster in a case of displaying feature vectors output from a trained model in a case of displaying a clustering result, thereby being a factor that reduces visibility of the clustering result.

On the other hand, the clustering apparatus 100 according to the present embodiment includes the data acquisition unit 101, the feature calculation unit 102, the variation degree calculation unit 103, and the display unit 105. The data acquisition unit 101 acquires a plurality of pieces of deformed data obtained by deforming the target data, and the trained model configured to receive input of the pieces of deformed data and output the feature vectors. The feature calculation unit 102 calculates the feature vector using the deformed data and the trained model. The variation degree calculation unit 103 calculates a degree of variation indicative of a degree of variation in feature vectors based on the feature vectors. The display unit 105 displays each feature vector according to the degree of variation.

With the above configuration, the clustering apparatus 100 according to the present embodiment can improve the visibility of clustering results by calculating a degree of variation in feature vectors of a plurality of pieces of deformed data obtained by deforming target data, and displaying a clustering result based on the calculated degree of variation. For example, as shown in FIG. 3, in a scatter diagram in which feature vectors output from the trained model are mapped, a boundary between clusters can be made easily viewable by displaying each feature vector in accordance with a degree of variation in original target data. By checking a degree of variation in the respective feature vectors, it is possible to check harmful data included in the target data and to analyze the performance of the trained model in consideration of the harmful data.

The display unit 105 may extract, as a candidate of harmful data, a piece of target data with a degree of variety of a predetermined value or more, and display the extracted piece of target data. In such a case, a user can effectively check data which is likely to be harmful data.

Furthermore, the clustering apparatus 100 further includes the cluster division unit 104. The cluster division unit 104 divides target data into a plurality of clusters based on the degree of variation. For example, the cluster division unit 104 decreases a degree of importance with respect to clustering of feature vectors with a high degree of variation. By considering a degree of variation at the time of clustering, the effect of harmful data in clustering can be reduced to improve the clustering performance.

Furthermore, a degree of variation in one piece of target data to be examined may be calculated and the calculated degree of variation may be presented to a user. By checking the degree of variation, the user can determine whether the piece of target data concerned is harmful data or not.

### Second Embodiment

A second embodiment will be described. The present embodiment corresponds to the first embodiment modified in configuration as described below. The descriptions of the same configurations, operations, and effects as those of the first embodiment are omitted.

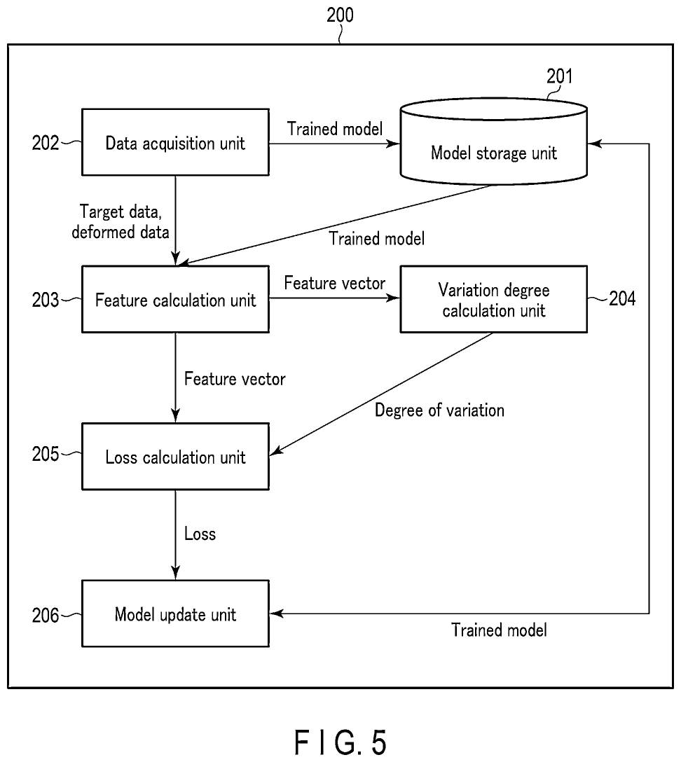

FIG. 5 is a diagram showing a configuration of a training apparatus 200 according to the present embodiment. The training apparatus 200 is an example of the feature vector calculation apparatus. The training apparatus 200 performs training on the trained model using information on a variation in feature vectors. The training apparatus 200 includes a model storage unit 201, a data acquisition unit 202, a feature calculation unit 203, a variation degree calculation unit 204, a loss calculation unit 205, and a model update unit 206. The model storage unit 201 is configured to store a trained model to be trained.

The data acquisition unit 202 acquires target data, a plurality of pieces of deformed data obtained by deforming the target data, and the trained model. The target data and the modified data are the same as those in the first embodiment, and explanations thereof will be omitted.

The trained model is a machine learning model that converts target data into a feature vector. As an example of the trained model, the present embodiment will describe a model trained through unsupervised learning (representation learning). The data acquisition unit 202 acquires DNN initialized with a random number, as a trained model. The data acquisition unit 202 stores the acquired trained model as a model to be trained in the model storage unit 201.

The feature calculation unit 203 calculates the feature vectors using the trained model and the deformed data as in the first embodiment. Furthermore, the feature calculation unit 203 calculates the feature vectors of the target data using the trained model and the target data as in the first embodiment.

The variation degree calculation unit 204 calculates a degree of variation indicative of a degree of variation in feature vectors based on the feature vectors calculated from the deformed data as in the first embodiment. A degree of variation in target data is also used as a degree of variation in pieces of deformed data generated from the aforementioned target data. The degree of variation is the same as that in the first embodiment, and the explanations thereof will be omitted.

The loss calculation unit 205 calculates a loss during training based on feature vectors of a plurality of pieces of target data. For example, the loss calculation unit 205 calculates a loss in an unsupervised learning method. As a loss in an unsupervised learning method, a loss in various unsupervised learning methods such as AE, VAE, BYOL, etc., can be used. In this calculation, the loss calculation unit 205 adjusts a degree of importance in training of each piece of target data, in accordance with a degree of variation. Specifically, the loss calculation unit 205 decrease a degree of importance in training of feature vectors with a high degree of variation. This can reduce the effect of harmful data in training of a trained model, thereby improving the training efficiency.

For example, the loss calculation unit 205 sets, as a weighting factor (weighting coefficient) of each feature vector in calculation of a loss, a value that is inversely proportional to a degree of variation in the corresponding target data. As a value that is inversely proportional to a degree of variation, for example, a reciprocal of the degree of variation, a reciprocal of a square of the degree of variation, etc., can be used. A feature vector generated from target data with a high degree of variation has a small weighting factor, thereby reducing the effect on training of data which is likely to be harmful data. Furthermore, instead of adjusting a weighting factor of a loss in accordance with a degree of variation, a temperature parameter may be adjusted in accordance with the degree of variation.

The model update unit 206 is configured to update the trained model based on a loss. For example, the model update unit 206 updates a weighting factor of DNN by an error backward propagation unit, based on a loss calculated by the loss calculation unit 205.

In the present embodiment also, the trained model is trained by a method that sets feature vectors of pieces of deformed data generated from the same piece of data so as to be close to be each other and considers the pieces of deformed data to be in the same class (category). Therefore, in a case where a plurality of pieces of deformed data generated based on harmful data are input into the trained model, the degree of variation in feature vectors output from the trained model becomes larger than that in a case where pieces of deformed data generated based on target data other than the harmful data are input into the trained model. Thus, the target data with a low degree of variation exhibits high reliability and low uncertainty, thereby being able to be considered as less likely to be harmful data. On the other hand, the target data with a low degree of variation exhibits low reliability and high uncertainty, thereby being able to be considered as highly likely to be harmful data.

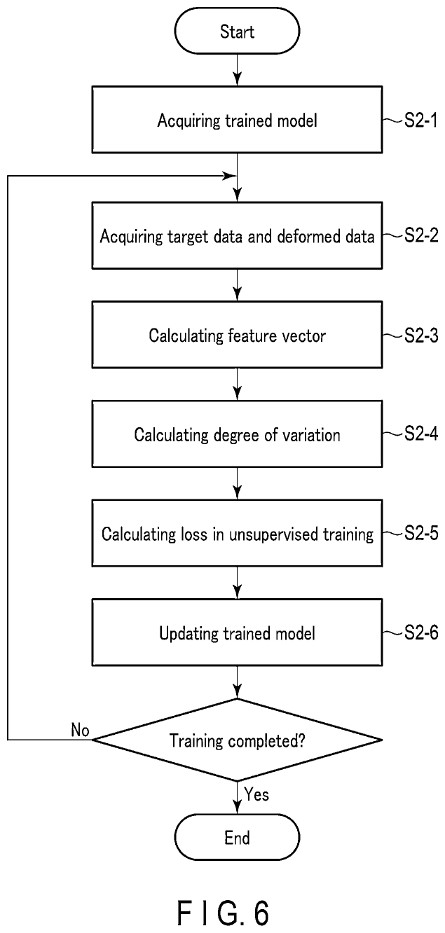

Next, the operation in the training processing executed by the training apparatus 200 according to the present embodiment will be described. FIG. 6 is a flowchart showing an example of a processing procedure in the training processing. The training processing is processing for performing unsupervised learning on a trained model using a target data group. Herein, as an example, a case will be described in which images showing one of the multiple types of animals are used as target data, and the images are each clustered for each animal type.

The processing procedure in each instance of processing described below is merely an example, and each instance of processing can be appropriately changed where possible. Furthermore, with respect to the processing procedure described below, steps can be omitted, replaced, and added as appropriate according to the embodiment.

### (Display Processing)

### (Step S2-1)

First, the data acquisition unit 202 acquires a trained model to be trained. The trained model may be read from a storage device inside the training apparatus 200 or a database outside the training apparatus 200, or may be input by a user. The data acquisition unit 202 transmits the acquired trained model to the model storage unit 201.

### (Step S2-2)

First, the data acquisition unit 202 acquires a target data group including a plurality of pieces of target data, and deformed data. The target data and the deformed data may be read from a storage device inside the training apparatus 200 or a database outside the training apparatus 200, or may be input by a user. Furthermore, the deformed data generated in advance may be acquired, or the deformed data may be acquired by executing data augmentation on the acquired target data.

The target data group is a group of images input as images showing animals. It is assumed that each image is a color image with an image size of 32×32 [pixel]. In this case, each piece of target data is image data of 3072 (=32×32×3) dimensional vectors, and the target data group is a vector data group of 3072 (=32×32×3) dimensional vectors.

### (Step S2-3)

Next, the feature calculation unit 203 reads a trained model to be trained from the model storage unit 201 and calculates feature vectors using the trained model. At this time, the feature calculation unit 203 inputs the target data and the deformed data into the trained model and acquires feature vectors output from the trained model. It is assumed that the number of dimensions of the feature vector is 128.

### (Step S2-4)

Next, the variation degree calculation unit 204 calculates a degree of variation using a feature vector of deformed data for each piece of target data. For example, the variation degree calculation unit 204 calculates a degree of variation for each piece of target data using the formula (1) described in step S1-3 of the first embodiment. In a case where a value of the memory bank is used as “u” in the formula (1), the variation degree calculation unit 204 acquires, as a feature vector, a value of a memory bank from the model storage unit 201.

### (Step S2-5)

Next, the loss calculation unit 205 calculates a loss in an unsupervised learning. At this time, the loss calculation unit 205 sets, as a weighting factor of a feature vector, a value that is inversely proportional to a degree of variation in the corresponding target data. A feature vector generated from target data with a high degree of variation has a small weighting factor, thereby reducing the effect on the calculation of a loss of data which is likely to be harmful data.

Formula (2) is an example of a formula for calculating a loss. In the formula (2), “Lj” represents a loss in an unsupervised learning corresponding to the j-th target data. “Lj” can be calculated by using, for example, a known unsupervised learning method using data augmentation. “Vj” represents a degree of variation in the j-th target data.

$$L = {\sum }_{j} {L}_{j} / {V}_{j} \qquad ( 2 )$$

By calculating a loss by weighting it with a reciprocal of a degree of variation of target data, it becomes possible to decrease a degree of importance in the calculation of a loss in harmful data whose degree of variation is assumed to be high. Since a degree of importance in the calculation of a loss in harmful data, the training efficiency is improved.

### (Step S2-6)

Next, the model update unit 206 acquires a trained model from the model storage unit 201 and updates the trained model based on a loss. For example, the model update unit 206 updates a weighting factor of DNN by an error backward propagation unit, based on a loss calculated by the loss calculation unit 205. The model update unit 206 stores the updated trained model in the model storage unit 201.

### (Step S2-7)

Upon completion of the processing in step S2-6, the training apparatus 200 makes a determination based on a termination condition as to whether training of a model is to be terminated or not. As a termination condition, a condition generally used for unsupervised learning of a trained model can be used. For example, such a termination condition is that the number of repetitions has reached a predetermined number or that the DNN weighting factor update amount becomes equal to or less than a predetermined value.

The training apparatus 200 performs training of a trained model by repeatedly executing the processing from step S2-2 to step S2-6 until the termination condition is satisfied. In a case where the termination condition is satisfied, the training apparatus 200 terminates training processing. Pieces of target data used for respective repeated steps are sampled randomly from among all pieces of training data. Furthermore, a probability distribution indicative of a frequency of use of each piece of target data in training is set in advance, and a piece of target data to be used in training is determined in accordance with the probability distribution.

### Advantageous Effect of Second Embodiment

The advantageous effects of the training apparatus 200 according to the present embodiment will be described.

The training apparatus 200 according to the present embodiment includes the data acquisition unit 202, the feature calculation unit 203, the variation degree calculation unit 204, the loss calculation unit 205, and the model update unit 206. The data acquisition unit 202 acquires a plurality of pieces of deformed data obtained by deforming the target data, and the trained model configured to receive input of the pieces of deformed data and output the feature vectors. The feature calculation unit 203 calculates the feature vector using the deformed data and the trained model. The variation degree calculation unit 204 calculates a degree of variation indicative of a degree of variation in feature vectors based on the feature vectors. The loss calculation unit 205 calculates a loss during training based on a plurality of pieces of target data. The model update unit 206 is configured to update the trained model based on a loss. Furthermore, the loss calculation unit 205 calculates a degree of importance in each piece of target data so as to be inversely proportional to a degree of variation.

The target data with a low degree of variation exhibits high reliability and low uncertainty, thereby being able to be considered as less likely to be harmful data. On the other hand, the target data with a low degree of variation exhibits low reliability and high uncertainty, thereby being able to be considered as highly likely to be harmful data. For this reason, the training apparatus 200 according to the present embodiment can improve the training efficiency by calculating a degree of variation in feature vectors of a plurality of pieces of deformed data obtained by deforming target data and adjusting a loss in training based on the degree of variation. Specifically, by decreasing a degree of importance in the calculation of a loss of feature vectors with a high degree of variation, the effect of harmful data in training can be reduced to improve the clustering performance.

### Modification of Second Embodiment

The present embodiment adjusts a degree of importance during training of each piece of target data in accordance with a degree of variation by adjusting a weighting factor in the calculation of a loss for each piece of target data. However, a degree of importance may be adjusted by using another method. For example, a degree of importance during training of target data may be adjusted by adjusting a distribution of target data to be sampled during training, in accordance with a degree of variation. In such a case, the loss calculation unit 205 decreases a frequency of use in a probability distribution as target data increases in degree of variation. In this manner, target data is sampled based on a probability distribution inversely proportional to a degree of variation, so that the effect of target data with a high degree of variation can be decreased.

Furthermore, target data with a high degree of variation can be excluded from target data for use in training. For example, with respect to target data with a degree of variety of a predetermined value or greater, the loss calculation unit 205 changes a frequency of use in a probability distribution to 0, thereby being able to calculate a loss while excluding target data with a degree of variety of a predetermined value or greater.

The present embodiment described the example in which a degree of variety is calculated during training. However, a degree of variety which is calculated in advance using another trained model after training may be used.

Furthermore, the present embodiment described the example in which unsupervised training is performed. However, the present application is applicable to supervised training, too. In such a case, the data acquisition unit 202 acquires, in addition to each piece of target data, a target label of each piece of target data, and the loss calculation unit 205 calculates a loss in supervised learning by using output of the trained model and the target data. At this time, the loss calculation unit 205 adjusts a degree of importance of a piece of target data with a high degree of variation during its training in accordance with a degree of variation of the piece of target data.

To improve the accuracy of a trained model, updating of the trained model may be performed through iterative optimization such as a stochastic gradient descent method. In such a case, the data acquisition unit 202 acquires a data set (data group) of target data which varies in random every time training is repeated.

### Modification of First Embodiment or Second Embodiment

The above embodiments described the case in which image data is used as target data; however, the above configuration is applicable to target data in any format. Examples of target data include audio data, table data, sensor data such as an acceleration and voltage, etc.

The above embodiments described the case in which a DNN is used as a trained model; however, the above configuration is applicable to all types of machine learning models. Examples of the trained model include a multiple regression analysis model, an SVM, a decision tree model, etc.

Furthermore, the feature vector calculation apparatus may be a retrieval apparatus including a function of retrieving data similar to predetermined data for retrieval (hereinafter referred to as “retrieval data”) from among pieces of target data. In this case, the retrieval apparatus includes a retrieval unit configured to calculate a similarity between each piece of target data and the retrieval data, and to retrieve target data similar to the retrieval data (hereinafter referred to as “similar data”) based on the similarity of each piece of target data. The retrieval unit acquires, as a feature vector for retrieval (hereinafter referred to as a “retrieval feature vector”), the retrieval data by inputting predetermined data into the trained model, and calculates a similarity between the acquired retrieval feature vector and the feature vector of each piece of target data. Thereafter, the retrieval unit extracts, as similarity data, target data with a degree of similarity equal to or greater than a threshold value, and presents the extracted similar data to a user.

Furthermore, in retrieving similar data, a retrieval result may be adjusted according to the degree of mixing of each piece of target data calculated by the integration unit. In such a case, the retrieval unit reduces the similarity of target data with a high degree of variety, thereby making it difficult for the target data with a high degree of variety to be extracted as similar data. Since target data with a high degree of variety is highly likely to be harmful data, the retrieval performance can be improved by reducing the influence of harmful data at the time of retrieving similar data.

### (Applied Example)

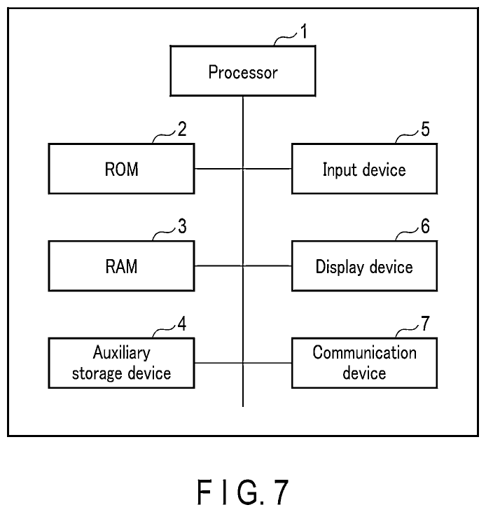

FIG. 7 is a diagram showing a hardware configuration of the clustering apparatus shown in FIG. 1 and the training apparatus shown in FIG. 5. As shown in FIG. 7, the clustering apparatus or the training apparatus is a computer including a processor 1, a read only memory (ROM) 2, a random access memory (RAN) 3, an auxiliary storage device 4, an input device 5, a display device 6, and a communication device 7. Transmission and reception of data and various signals between the processor 1, the ROM 2, the RAM 3, the auxiliary storage device 4, the input device 5, the display device 6, and the communication device 7 are performed via a bus.

The processor 1 is an integrated circuit configured to control the overall operation of the clustering apparatus or the training apparatus. The processor 1 is an example of processing circuitry. For example, the processor 1 includes a central processing unit (CPU), a graphics processing unit (GPU), a digital signal processor (DSP), and/or a floating-point unit (FPU). The processor 1 may include an internal memory and an I/O interface. The processor 1 executes various types of processing by interpreting and computing programs stored in advance in the ROM 2, the auxiliary storage device 4, etc. The processor 1 may be partially or entirely realized by hardware such as an application specific integrated circuit (ASIC) or a field programmable gate array (FPGA), etc.

The ROM 2 is a nonvolatile memory configured to store various types of data. For example, the ROM 2 stores data, a setting value, etc., used by the processor 1 to execute various types of processing. The ROM 2 may include a non-transitory computer readable storage medium configured to store a program to be executed by the processor 1.

The RAM 3 is a volatile memory used for reading and writing data. The RAM 3 temporarily stores data used by the processor 1 to execute various types of processing. The RAM 3 provides a work area for the processor 1.

The auxiliary storage device 4 is a nonvolatile memory configured to store various types of data. For example, the auxiliary storage device 4 stores data and setting values used by the processor 1 to execute various types of processing, data generated by various types of processing by the processor 1, etc. The auxiliary storage device 4 is composed of a hard disk drive (HDD), a solid state drive (SSD), an integrated circuit storage device, etc. The auxiliary storage device 4 may include a non-transitory computer readable storage medium configured to store a program executed by the processor 1.

The input device 5 receives input of various operations from a user. As the input device 5, a keyboard, a mouse, various switches, a touch pad, a touch panel display, etc., can be used. An electrical signal (hereinafter referred to as an “operation signal”) corresponding to a received operation input is supplied to the processor 1.

The display device 6 displays various types of data under the control of the processor 1. As the display device 6, a cathode-ray tube (CRT) display, a liquid crystal display, an organic electro luminescence (EL) display, a light-emitting diode (LED) display, a plasma display, or any other display can be used as appropriate. The display device 6 may be a projector.

The communication device 7 includes a communication interface such as a network interface card (NIC) for performing data communication with various devices connected to the clustering apparatus or the training apparatus via a network. Note that an operation signal may be supplied from a computer connected via the communication device 7 or an input device included in the computer, and various types of data may be displayed on a display device, etc., included in the computer connected via the communication device 7. However, to simplify the following explanation, it is assumed that a source of the operation signal is the input device 5, and a display destination of the various types of data is the display device 6, unless otherwise specified. The input device 5 is replaceable with a computer connected via the communication device 7 or an input device included in the computer, and the display device 6 is replaceable with a display device, etc., included in the computer connected via the communication device 7.

The clustering apparatus of the training apparatus does not necessarily include all of the processor 1, the ROM 2, the RAM 3, the auxiliary storage device 4, the input device 5, the display device 6, and the communication device 7. Some of the processor 1, the ROM 2, the RAM 3, the auxiliary storage device 4, the input device 5, the display device 6, and the communication device 7 may not be provided as appropriate. The clustering apparatus or the training apparatus may be provided with any additional hardware device useful in performing the processing according to the present embodiment. The clustering apparatus or the training apparatus is not necessarily physically composed of one computer, but may be composed of a computer system having a plurality of computers communicatively connected via a wire, a network line, etc. The assignment of a series of processing according to the present embodiment to a plurality of processors 1 respectively installed in a plurality of computers can be freely set. All the processors 1 may execute the entirety of processing in parallel. Alternatively, one or some of the processors 1 may be assigned a specific part of the processing, and the series of processing according to the present embodiment may be executed as the entirety of the computer system.

Thus, according to any of the embodiments described above, it is possible to provide a feature vector calculation apparatus, a clustering apparatus, a training apparatus, a method, and a program which are capable of supporting clustering in consideration of harmful data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A feature vector calculation apparatus comprising processing circuitry configured to:
acquire target data, a plurality of pieces of deformed data obtained by deforming the target data, the target data comprising a plurality of pieces of target data, and a trained model adapted to receive input of each of the pieces of deformed data and output a feature vector;
calculate the feature vector using each of the pieces of the deformed data and the trained model; and
calculate, for each of the pieces of target data, a degree of variation indicative of a degree of variation in the feature vector.

2. A clustering apparatus comprising the feature vector calculation apparatus according to claim 1,
wherein the processing circuitry is configured to divide the target data into a plurality of clusters based on the degree of variation.

3. The clustering apparatus according to claim 2, wherein the processing circuitry is configured to cause a display to display the feature vector with a degree of emphasis according to the degree of variation.

4. A training apparatus comprising the feature vector calculation apparatus according to claim 1,
wherein the processing circuitry is configured to:
calculate a loss in training based on the plurality of pieces of target data so as to decrease an effect given on the training by a piece of target data the degree of variation of which is high; and
update the trained model based on the loss.

5. The training apparatus according to claim 4, wherein the processing circuitry is configured to calculate a degree of importance of the target data in calculation of the loss so as to be inversely proportional to the degree of variation.

6. The training apparatus according to claim 4, wherein the processing circuitry is configured to calculate the loss based on the target data sampled based on a probability distribution inversely proportional to the degree of variation.

7. The training apparatus according to claim 4, wherein the processing circuitry is configured to calculate the loss by excluding a piece of target data having the degree of variation of a predetermined value or greater.

8. The feature vector calculation apparatus according to claim 1, wherein the processing circuitry is configured to:
calculate a similarity between a retrieval feature vector obtained by inputting retrieval data in the trained model and the feature vector, for each of the pieces of target data;
retrieve similar data similar to the retrieval data from among the plurality of pieces of the target data in accordance with the similarity; and
calculate the similarity in accordance with the degree of variation.

9. The feature vector calculation apparatus according to claim 8, wherein the processing circuitry is configured to decrease the similarity of a piece of target data with the high degree of variation.

10. A method comprising:
acquiring target data, a plurality of pieces of deformed data obtained by deforming the target data, the target data comprising a plurality of pieces of target data, and a trained model adapted to receive input of each of the pieces of deformed data and output a feature vector;
calculating the feature vector using each of the pieces of the deformed data and the trained model; and
calculating, for each of the pieces of target data, a degree of variation indicative of a degree of variation in the feature vector.

11. A non-transitory computer-readable storage medium storing a program for causing a computer to execute:
a function of acquiring target data, a plurality of pieces of deformed data obtained by deforming the target data, the target data comprising a plurality of pieces of target data, and a trained model adapted to receive input of each of the pieces of deformed data and output a feature vector;
a function of calculating the feature vector using each of the pieces of the deformed data and the trained model; and
a function of calculating, for each of the pieces of target data, a degree of variation indicative of a degree of variation in the feature vector.
